(19) United States
(12) Patent Application Publication
(10) Pub. No.: US 2005/0128058 A1
(43) Pub. Date: Jun. 16, 2005

(54) Alarm sound emitting apparatus

(76) Inventors: Masayuki Oyagi, Kyoto (JP); Isao Nobayashi, Osaka (JP); Seika Ishikawa, Osaka (JP)

Correspondence Address: DICKSTEIN SHAPIRO MORIN & OSHINSKY LLP, 2101 L Street, NW, Washington, DC, 20037, US

(21) Appl. No.: 11/008,153

(22) Filed: Dec. 10, 2004

(30) Foreign Application Priority Data
Dec. 11, 2003 (JP) J. 2003-413565

(51) Int. Cl. G08B 3/00

(52) U.S. Cl. 340/384.1

(57) ABSTRACT

An alarm sound emitting apparatus is installed at inside of an outer shell member surrounding a space and emits alarm sound to outside by vibrating an outer shell member. The alarm sound emitting apparatus is provided with a piezoelectric element for generating vibration, a support rod for supporting the piezoelectric element and transmitting vibration, an elastic member for pressing the support rod to the vibrating plate, a magnet for fixing the support rod to the vibrating plate, a circuit board formed with various circuits including a circuit of driving the piezoelectric element, and a cabinet for containing respective elements of the piezoelectric element and the like.

This application claims foreign priority based on Japanese patent application JP 2003-413565, filed on Dec. 11, 2004, the contents of which is incorporated herein by reference in its entirety.

### BACKGROUND OF THE INVENTION

1. Field of the Invention

The present invention relates to an alarm sound emitting apparatus, particularly relates to an alarm sound emitting apparatus installed at inside of a compartment of a vehicle or the like for emitting alarm sound.

2. Description of the Related Art

In recent years, there is frequently brought about an incident in which an article placed at inside of a compartment of a vehicle or the like is robbed. As a countermeasure against the robbery, various robbery preventing systems have been developed. As a robbery preventing system, it is general to sense robbery by a sensor, inform robbery by communication, or intimidate by emitting sound or the like.

In order to prevent robbery by intimidation by emitting sound, there is conceivable to use a sound emitting apparatus or an acoustic apparatus for emitting sound. With regard to the sound emitting apparatus or acoustic apparatus, in related arts, various applications have been filed, for example, JP-A-2000-134682 describes a sound emitting apparatus using a piezoelectric vibrating plate as an example of a sound emitting apparatus of a related art.

When intimidation is carried out by emitting sound to prevent robbery at inside of a compartment by using the above-described sound emitting apparatus, it is assumed that alarm sound is emitted by pertinent sound pressure to outside even when inside of the compartment is acoustically shielded from outside or significant physical and/or spiritual damage is prevented from being caused to a person, an animal or the like staying at inside of the compartment when the apparatus is erroneously operated.

However, the sound emitting apparatus of the related art as described in the publication has been developed on the premise of being used mainly as a sound source of an acoustic apparatus. In this sound emitting apparatus, a consideration is not given to a structure of emitting alarm sound to outside by pertinent sound pressure when inside of the compartment is acoustically shielded from outside, and a structure of reducing physical and/or spiritual damage by sound pressure from being caused to a person, an animal or the like staying at inside of the compartment when the apparatus is erroneously operated. Therefore, the sound emitting apparatus of the related art is not suitable for being used as an alarm sound emitting apparatus.

Further, in an alarm sound emitting apparatus of a type of emitting sound to outside of a compartment by transmitting vibration to a vibrating plate, it is desired that the apparatus can be switched to install to a pertinent position at which a sound volume at outside is increased. However, in the sound emitting apparatus described in the publication, a foot portion is fixed to an acoustic vibration plate by an adhering agent and therefore, there also poses a problem that once the apparatus is installed, it is difficult to switch to install the apparatus to the pertinent position.

### SUMMARY OF THE INVENTION

It is an object of the invention to provide an alarm sound emitting apparatus capable of emitting alarm sound to outside at pertinent sound pressure even when inside of a compartment is acoustically shielded from outside, capable of reducing physical and/or spiritual damage by sound pressure from being caused to a person, an animal or the like staying at inside of the compartment even when the apparatus is erroneously operated, and facilitating to switch to install the apparatus.

An alarm sound emitting apparatus according to the invention is an alarm sound emitting apparatus installed at an inner portion of an outer shell member surrounding a space, the alarm sound emitting apparatus comprising: a vibration generating member for generating a vibration; a vibration transmitting member for transmitting the vibration from the vibration generating member to the outer shell member; and a fixing member for fixing the vibration transmitting member to the outer shell member attachably to and detachably from the outer shell member, wherein an alarm sound is emitted to an outer portion of the space by vibrating the outer shell member. Further, the alarm sound emitting apparatus may comprise: an elastic member for pressing the vibration transmitting member to a side of the outer shell member. Further, the vibration transmitting member may directly be fixed to the outer shell member, or may indirectly be fixed thereto.

In the above-mentioned alarm sound emitting apparatus, preferably, the vibration generating member is a piezoelectric element, the vibration transmitting member is a support rod for supporting the piezoelectric element and transmitting the vibration from the piezoelectric element to the outer shell member, the fixing member is a magnet for fixing the support rod to the outer shell member attachably to and detachably from the outer shell member. Further, the alarm sound emitting apparatus may comprise: an elastic member for pressing the support rod to a side of the outer shell member.

In the above-mentioned alarm sound emitting apparatus, preferably, the vibration generating member is a piezoelectric element, and the vibration transmitting member is a support rod for supporting the piezoelectric element and transmitting the vibration from the piezoelectric element and a magnet fixed to the support rod, transmitting the vibration transmitted from the piezoelectric element to the support rod to the outer shell member, and wherein the magnetic also serves as the fixing member for fixing the support rod to the outer shell member. Further, the alarm sound emitting apparatus may comprise: an elastic member for pressing the support rod and the magnet to a side of the outer shell member. Further, the support rod may directly support the piezoelectric element, or may indirectly support the piezoelectric element.

The alarm sound emitting apparatus preferably further comprises: a cabinet for containing the vibration generating member and the vibration transmitting member therein, wherein the fixing member fixes the cabinet to the outer shell member attachably to and detachably from the outer shell member.

Further, the alarm sound emitting apparatus may comprise: an elastic member contained in the cabinet for pressing the vibration transmitting member to a side of the outer shell member.

In the alarm sound emitting apparatus, preferably, the vibration generating member is a vibrating unit including a vibrating member for generating a vibration, the vibration transmitting member is a vibration transmitting member for supporting the vibrating member and transmitting the vibration from the vibrating member to the outer shell member, the fixing member is a magnet for fixing the vibration transmitting member to the outer shell member. Further, the alarm sound emitting apparatus may comprise: an elastic member for pressing the vibration transmitting member to a side of the outer shell member.

According to the alarm sound emitting apparatus of the invention, the alarm sound can be emitted to outside by vibrating the outer shell member and therefore, even when the space surrounded by the outer shell member is acoustically shielded from the outside, the alarm sound can be emitted to outside of the space at pertinent sound pressure. Further, the alarm sound having a pertinent volume can be emitted to outside of the space without emitting the alarm sound having a large volume at inside of the space surrounded by the outer shell member and therefore, even when the alarm sound emitting apparatus is erroneously operated, physical and/or spiritual damage by the sound pressure caused to a person, an animal or the like staying at inside of the space can be reduced. Further, the outer shell member is fixed with respective elements of the alarm sound emitting apparatus attachably thereto and detachably therefrom and therefore, the alarm sound emitting apparatus can easily be switched to install.

### BRIEF DESCRIPTION OF THE DRAWINGS

FIG. 1 is a sectional view showing a state of installing an alarm sound emitting apparatus according to Embodiment 1 of the invention in a box-shaped compartment.

FIG. 2 is a perspective view of a piezoelectric element which can be used in respective embodiments of the invention.

FIG. 3 is a perspective view of a modified example of the piezoelectric element which can be used in the respective embodiments of the invention.

FIG. 4 is a sectional view of the alarm sound emitting apparatus according to Embodiment 1 of the invention.

FIG. 5 is a sectional view of an alarm sound emitting apparatus according to Embodiment 2 of the invention.

FIG. 6 is a sectional view showing a state of installing the alarm sound emitting apparatus according to Embodiment 2 of the invention.

FIG. 7 is a sectional view showing a state of installing an alarm sound emitting apparatus according to Embodiment 3 of the invention.

FIG. 8 is a sectional view showing a state of installing a modified example of the alarm sound emitting apparatus according to Embodiment 3 of the invention.

FIG. 9 is a sectional view showing a state of installing an alarm sound emitting apparatus according to Embodiment 4 of the invention.

FIG. 10 is a sectional view showing a state of installing an alarm sound emitting apparatus according to Embodiment 5 of the invention.

FIG. 11 is a schematic view showing an example of installing an alarm sound emitting apparatus according to Embodiment 6 of the invention.

### DETAILED DESCRIPTION OF THE INVENTION

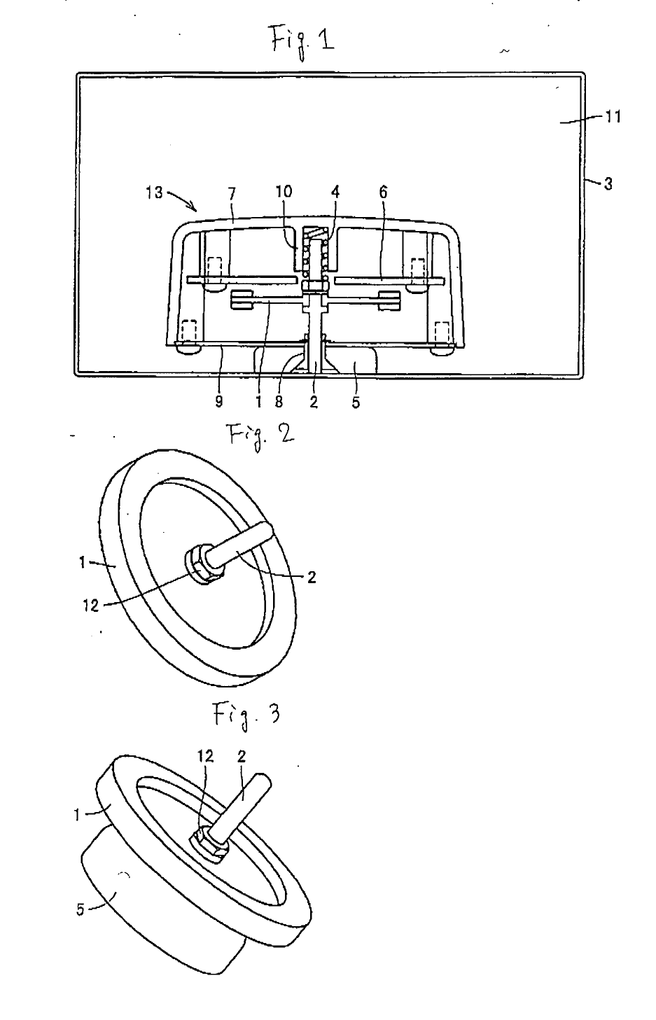

An explanation will be given of alarm sound emitting apparatuses according to embodiments of the invention in reference to FIG. 1 through FIG. 12 as follows.

### Embodiment 1

FIG. 1 is a view showing a state that an alarm sound emitting apparatus (alarm emitting apparatus) 13 according to Embodiment 1 of the invention is installed at a compartment inside (space) 11 surrounded by a box-shaped vibrating plate (acoustic vibrating plate: outer shell member) 3. FIG. 4 is an enlarged view of the alarm sound emitting apparatus 13.

Further, in the example of FIG. 1, there is shown the example of installing the alarm sound emitting apparatus 13 in a room specified by the vibrating plate 3 constituted by a metal plate or the like. However, the alarm sound emitting apparatus 13 can be installed at any space inside so far as it is a space inside surrounding by an outer shell member capable of transmitting vibration.

As shown by FIG. 1 and FIG. 4, the alarm sound emitting apparatus 13 is provided with a piezoelectric element 1, a support rod 2, an elastic member 4, a magnet 5, a circuit board 6, a cabinet (casing) 7, a bearing 8, a bottom plate 9, and a boss portion 10.

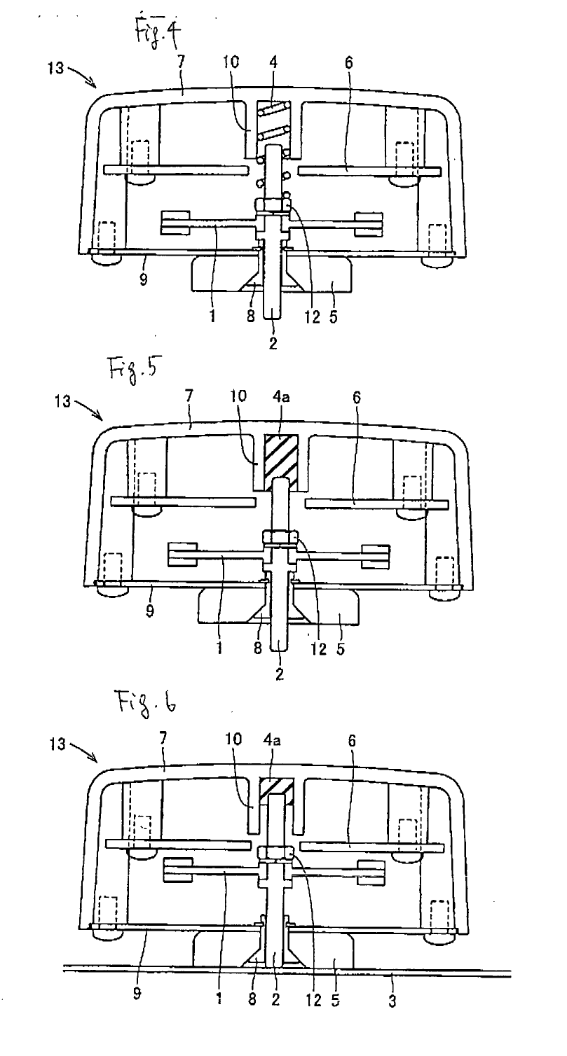

The piezoelectric element 1 functions as vibration generating member for generating vibration, and include a piezoelectric vibrating plate substantially in a circular shape, and a vibration control member in a ring-like shape installed at a peripheral edge portion of the piezoelectric vibrating plate as shown by, for example, FIG. 2 and FIG. 3. A center portion of the piezoelectric element 1 is provided with a hole, and the support rod 2 is inserted into the hole. As shown by FIG. 2 and FIG. 3, the piezoelectric element 1 is fixed to the support rod 2 by a fixing member 12 of a nut or the like. Further, as shown by FIG. 3, the support rod 2 may be mounted with the magnet 5 which is provided with a bottom face (adsorbing face) which is flat and extends in a direction orthogonal to a longitudinal direction of the support rod 2.

The support rod 2 directly or indirectly supports the piezoelectric element 1. The support rod 2 is also provided with a function as a vibration transmitting member for transmitting vibration from the piezoelectric element 1 to the vibrating plate 3. One end of the support rod 2 is brought into contact with the vibrating plate 3 and other end thereof is received by the boss portion 10 provided at inside of the cabinet 7. As a material of the support rod 2, from a view point of strength and a vibration transmitting function, for example, a metal or the like can be pointed out.

The elastic member 4 is installed at inside of the boss portion 10 of the cabinet 7. Although according to the example of FIG. 1 and FIG. 4, a coil spring is used as the elastic member 4, an elastic member other than the coil spring can be used so far as the elastic member can urge the support rod 2 to a side of the vibrating plate 3. By mounting the elastic member 4 at inside of the cabinet 7 in this way, the support rod 2 can be pressed to the vibrating plate 3, and the support rod 2 can be brought into contact with the vibrating plate 3 in a state of applying desired pressure. Thereby, vibration from the piezoelectric element 1 can efficiently be transmitted to the vibrating plate 3 via the support rod 2. Further, even when there are more or less recesses and projections in the vibrating plate 3, the support rod 2 can firmly be brought into contact with the vibrating plate 3.

According to the example of FIG. 1 and FIG. 4, the magnet 5 functions as a fixing member for fixing the alarm sound emitting apparatus 13 to the vibrating plate 3. As described above, the magnet 5 is provided with the bottom face (adsorbing face) which is flat and extends in a direction orthogonal to the longitudinal direction of the support rod 2 as described above. Thereby, when the vibrating plate 3 is provided with a flat surface, the support rod 2 can be erected in a direction orthogonal to the surface of the vibrating plate 3 while increasing a contact area of the vibrating plate 3 and the magnet 5.

Further, when the vibrating plate 3 is not provided with the flat surface, a shape of the bottom face (adsorbing face) of the magnet 5 may be selected to be a shape in correspondence with a surface shape of the vibrating plate 3 to be along the surface of the vibrating plate 3. Further, a flat portion may be provided at a surface of the vibrating plate 3, and the flat portion may be attached with the magnet 5 having the flat bottom face (adsorbing face).

The magnet 5 is provided with a hole for receiving the support rod 2 at a center portion thereof, and the support rod 2 is inserted into the hole. In the example of FIG. 1 and FIG. 4, the bearing 8 is mounted to inside of the hole of the center portion of the magnet 5. The support rod 2 is supported by the bearing 8 to be able to vibrate in an axial direction on an inner side of the magnet 5. Further, an arbitrary fixing member other than the magnet 5 can be used so far as the fixing member can fix the alarm sound emitting apparatus 13 attachably and detachably to and from the vibrating plate 3.

By providing the magnet 5 at the alarm sound emitting apparatus 13 as described above, the alarm sound emitting apparatus 13 can be fixed to the vibrating plate 3 by a magnetic traction force thereof. In this case, the vibrating plate 3 needs to be constituted by a material exerted with the magnetic traction force from the magnet 5, for example, a metal.

An explanation will be given here of a relationship among the magnetic traction force (adsorbing force) by the magnet 5, an elastic force by the elastic member 4, and a force generated when the piezoelectric element 1 is vibrated in an up and down direction by receiving an electric signal.

When the magnet 5 is not always brought into close contact with the vibrating plate 3, vibration from the piezoelectric element 1 is not efficiently transmitted to the vibrating plate 3 and therefore, it is preferable that the magnetic traction force by the magnet 5 is larger than the elastic force by the elastic member 4 and the force generated at the piezoelectric element 1. Further, the elastic force by the elastic member 4 needs to be smaller than the force generated when the piezoelectric element 1 is vibrated in the up and down direction by receiving the electric signal such that when the piezoelectric element 1 is vibrated in the up and down direction by receiving the electric signal, the movement is not hampered by the elastic member 4.

As described above, various conditions of materials of the magnet 5, the elastic member 4 and the like are set to establish a relationship of the magnetic traction force by the magnet 5>the force generated when the piezoelectric element 1 is vibrated in the up and down direction by receiving the electric signal>the elastic force by the elastic member 4.

The circuit board 6 is fixed to the cabinet 7 by a fixing member of a screw or the like and is provided with various electric circuits on a surface thereof. Specifically, there are formed various electric circuits of a circuit for controlling to operate the piezoelectric element 1 such as a circuit for driving the piezoelectric element 1, a receiving circuit for receiving various signals such as a signal for driving the piezoelectric element 1 and the like, and a signal processing circuit for processing signals on the circuit board 6. The circuit board 6 is also provided with a hole at a center thereof to which the support rod 2 is inserted into the hole.

The cabinet 7 contains the piezoelectric element 1, the support rod 2, the elastic member 4 and the circuit board 6 and is provided with an opening at a bottom portion thereof in the example of FIG. 1 and FIG. 4. The cabinet 7 may be constituted by a comparatively hard member, and can be constituted by, for example, a plastic or the like. The bottom plate 9 is attached to the cabinet 7 to close the opening of the cabinet 7. A hole is provided also at a center of the bottom plate 9 and the support rod 2 is inserted into the hole.

In the example of FIG. 1 and FIG. 4, the bearing 8 is fixed to the bottom plate 9, and one end of the bearing 8 is projected from the bottom plate 9 to an inner portion of the cabinet 7. The support rod 2 is provided with a bulged portion (enlarged diameter portion) bulged in a diameter direction of the support rod 2 at a center portion in a longitudinal direction. Before installing the alarm sound emitting apparatus 13, as shown by FIG. 4, the bulged portion of the support rod 2 is brought into contact with the one end of the bearing 8 by the elastic force from the elastic member 4. That is, the end portion of the bearing 8 on the side of the support rod 2 functions as a stopper of the support rod 2. Thereby, the support rod 2 can be prevented from being drawn from the cabinet 7.

Further, the bearing 8 is provided with a bulged portion (enlarged diameter portion) bulged in the diameter direction of the bearing 8 at the end portion (bottom portion). The bulged portion of the bearing 8 is provided with substantially a taper shape, an outer peripheral face of the bulged portion is constituted by an inclined face inclined such that the diameter of the bearing 8 is increased by being proximate to the end portion of the bearing 8. Also an inner peripheral face of the magnet 5 is provided with an inclined face inclined such that an inner diameter of the magnet 5 is increased toward the bottom face of the magnet 5 in correspondence with the bulged portion of the bearing 8. By engaging the bulged portion of the bearing portion 8 with the magnet 5, the magnet 5 can be avoided from being detached from the bearing 8.

Further, it is preferable to install a sensor at the compartment inside 11 in order to sense whether an abnormal situation is brought about at the compartment inside 11. The sensor typically includes a transmitter for transmitting an abnormal signal informing the abnormal situation.

For example, it is conceivable to attach a pressure sensor at the alarm sound emitting apparatus 13 to sense the occurrence of the abnormal situation by a change in pressure and transmit the abnormal signal. Further, it is also conceivable to install a sensor other than the pressure sensor, such as an infrared ray sensor, a vibration sensor for sensing abnormal vibration, a sound sensor for sensing abnormal sound, a temperature sensor for sensing a change in temperature or the like.

Next, an explanation will be given of operation of the alarm sound emitting apparatus 13 according to Embodiment 1.

For example, when an abnormal situation occurs at the compartment inside 11 shown in FIG. 1, the abnormal situation is sensed by the above-described various sensors. In accordance with sensing the occurrence of the abnormal situation by the various sensors, an abnormal signal is transmitted from the transmitter included in the sensor and the abnormal signal is received by the receiving circuit disposed on the circuit board 6.

In accordance with receiving the abnormal signal by the receiving circuit, the circuit for driving the piezoelectric element 1 is operated to thereby drive the piezoelectric element 1. By driving the piezoelectric element 1, vibration is generated at the piezoelectric element 1, and the vibration is transmitted to the vibrating plate 3 via the support rod 2. When vibration from the piezoelectric element 1 is transmitted to the vibrating plate 3, the vibrating plate 3 is vibrated and sound can be emitted to outside by vibrating the vibrating plate 3. Further, it is also possible to transmit vibration to other member via the vibrating plate 3 by mechanically connecting the vibrating plate 3 and the other member to transmit sound to outside by vibrating the other member.

As described above, according to the alarm sound emitting apparatus 13 of Embodiment 1, the alarm sound emitting apparatus 13 per se does not emit sound directly at inside of the compartment but sound can be emitted to outside by vibrating the member transmitted with vibration from the alarm sound emitting apparatus 13. Therefore, even when inside of the compartment is acoustically shielded from outside, alarm sound having pertinent sound pressure can be emitted outside without emitting large sound at inside of the compartment.

Further, alarm sound having pertinent sound pressure can be emitted to outside of the compartment without emitting large sound at inside of the compartment and therefore, even when the alarm sound emitting apparatus 13 is erroneously operated, physical and/or spiritual damage by alarm sound can be reduced from being caused to a person, an animal or the like staying at inside of the compartment.

Further, since the alarm sound emitting apparatus 13 is fixed to the vibrating plate 3 by the magnet 5, the alarm sound emitting apparatus 13 can easily be removed from the vibrating plate 3 and switched to install to an optimum position of a wall (outer shell member) surrounding inside of the compartment.

### Embodiment 2

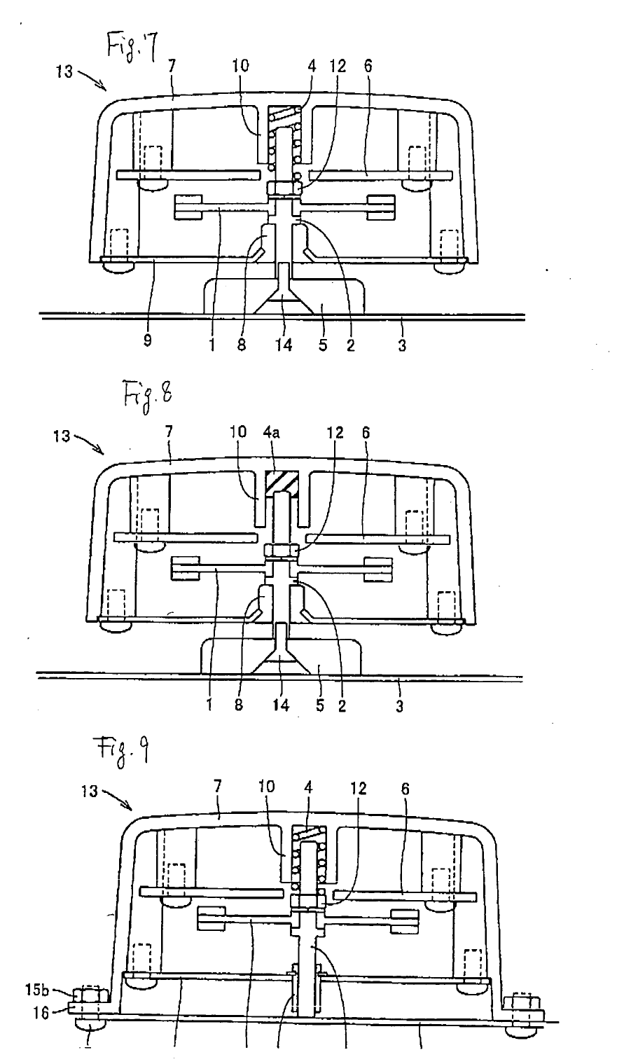

Next, Embodiment 2 of the inventing will be explained in reference to FIG. 5 and FIG. 6 as follows.

According to Embodiment 2, as shown by FIG. 5 and FIG. 6, rubber or elastic sponge is adopted as an elastic member 4a in place of the coil spring. Also in this case, an effect similar to that of Embodiment 1 can be expected. Other constitution of the alarm sound emitting apparatus 13 is similar to that of the case shown in FIG. 4.

### Embodiment 3

Next, Embodiment 3 of the invention and a modified example thereof will be explained in reference to FIG. 7 and FIG. 8 as follows. Although according to the above-described respective embodiments, the magnet 5 and the support rod 2 are constituted by separate members, according to Embodiment 3, as shown by FIG. 7, the magnet 5 and the support rod 2 are integrated.

Further in details, a connecting member 14 is provided between the magnet 5 and the support rod 2, and the magnet 5 and the support rod 2 are mechanically connected via the connecting member 14. In accordance therewith, the bearing 8 is separated from the magnet 5. Further, the connecting member 14 is separated from the vibrating plate 3. Other constitution is basically similar to that of the case shown in FIG. 4.

In the case of Embodiment 3, vibration from the piezoelectric element 1 is transmitted to the vibrating plate 3 via the support rod 2 and the magnet 5, and similar to the case of Embodiment 1, sound can be emitted to outside by vibrating a member transmitted with vibration from the alarm sound emitting apparatus 13. Therefore, an effect similar to that in the case of Embodiment 1 can be expected.

Next, a modified example of Embodiment 3 will be explained in reference to FIG. 8. As shown by FIG. 8, the elastic member 4a of rubber, elastic sponge or the like may be used in place of the elastic member 4 of a coil spring or the like. Also in this case, an effect similar to that in the case of FIG. 7 can be expected.

### Embodiment 4

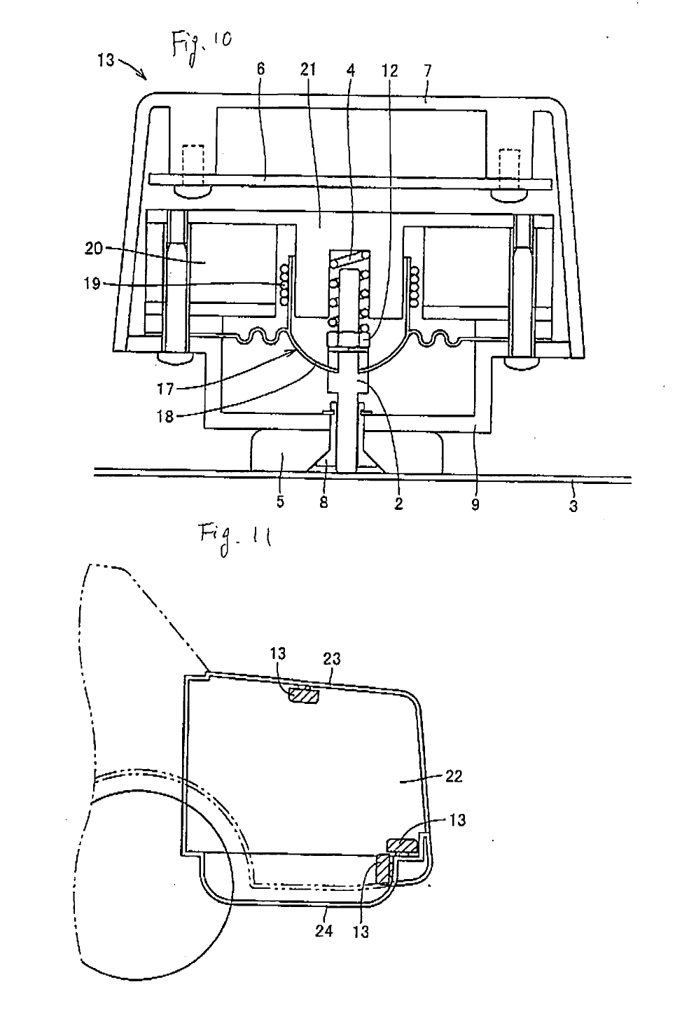

Next, Embodiment 4 of the invention will be explained in reference to FIG. 9. According to Embodiment 4, as fixing member other than a magnet is adopted as means for fixing the alarm sound emitting apparatus 13 to the vibrating plate 3.

Specifically, as shown by FIG. 9, a flange portion 16 is provided at a peripheral edge portion of the cabinet 7, a through hole is provided at the flange portion 16, a fixing member 15a of a screw or the like is inserted into the through hole, and a fixing member 15b of a nut or the like is screwed to the fixing member 15a from above the flange portion 16. By attaching the fixing members 15a, 15b to interpose the flange portion 16 of the cabinet 7 and the vibrating plate 3 in this way, the alarm sound emitting apparatus 13 can be fixed to the vibrating plate 3 attachably thereto and detachably therefrom.

Further, according to Embodiment 4, in accordance with omitting the magnet 5, a shape of the bearing 8 is made to differ from that in the case of FIG. 4. Further specifically, the bearing 8 is constituted by a shape substantially in a cylindrical shape and the end portion of the bearing 8 is not provided with the bulged portion. Other constitution is basically similar to that in the case shown in FIG. 4.

Also in the case of Embodiment 4, vibration from the piezoelectric element 1 is transmitted to the vibrating plate 3 via the support rod 2 and therefore, similar to the case of Embodiment 1, sound can be emitted to outside by vibrating a member transmitted with vibration from the alarm sound emitting apparatus 13. Therefore, an effect similar to that of the case of Embodiment 1 can be expected. Further, the alarm sound emitting apparatus 13 can easily be detached from the vibrating plate 3 by detaching the fixing members 15a, 15b and therefore, the alarm sound emitting apparatus 13 can easily be switched to install to an optimum position at inside of the compartment.

### Embodiment 5

Next, Embodiment 5 of the Invention will be explained in reference to FIG. 10. The alarm sound emitting apparatus 13 according to Embodiment 5 adopts a speaker driver unit (vibrating unit) as vibration generating member. The speaker driver unit 17 includes a vibrating member 18 having a dome-like portion at a center thereof, a coil 19, a magnet 20, and a yoke 21. The alarm sound emitting apparatus 13 is fixed to the cabinet 7 via a fixing member of a screw or the like.

The support rod 2 includes a recess portion inserted into the dome-like portion of the vibrating member 18 for receiving an end portion of the vibrating member 18 at an outer periphery thereof. By receiving the end portion of the vibrating member 18 into the recess portion of the outer periphery of the support rod 2, the support rod 2 and the vibrating member 18 are engaged with each other. Thereby, vibration from the vibrating member 18 can be transmitted to the support rod 2. Further, a bulged portion provided at a center portion in the longitudinal direction of the support rod 2 and an end portion of the vibrating member 18 may be engaged with each other.

One end of the support rod 2 is brought into contact with the vibrating plate 3 and other end of the support rod 2 is received by inside of a recess portion provided at a center projected portion of the yoke 21. Further, the elastic member 4 is installed at inside of the recess portion of the yoke 21. The coil 19 is wound around an outer periphery of the center projected portion of the yoke 21 having the recess portion via a cylindrical portion of the vibrating member 18. Further, the magnet 20 is arranged at a surrounding of the coil 19.

By adopting the speaker driver unit 17 as described above, although shapes of the bottom plate 9 and the circuit board 6 more less differ, a constitution other than the above-described is basically similar to that of the case shown in FIG. 4.

Further, similar to the case of Embodiment 1, the circuit board 6 is formed with various electric circuits of a circuit for controlling to operate the speaker driver unit 17 such as a circuit for driving the speaker driver unit 17, a receiving circuit for receiving various signals of a signal for driving the speaker driver unit 17 and the like, and a signal processing circuit for processing signals.

Next, operation of the alarm sound emitting apparatus 13 according to Embodiment 5 will be explained. Also according to Embodiment 5, a sensor of a pressure sensor or the like is installed at the alarm sound emitting apparatus 13 or inside of the compartment.

When an abnormal situation occurs at inside of a compartment installed with the alarm sound emitting apparatus 13, the abnormal state is sensed by the above-described sensors. In accordance with sensing the occurrence of the abnormal state by the sensors, an abnormal signal is transmitted from the transmitter included in the sensors and the abnormal signal is received by the receiving circuit on the circuit board 6.

In accordance with receiving the abnormal signal by the receiving circuit, the circuit for driving the speaker driver unit 17 is operated, and electricity is conducted to the coil 19. Thereby, vibration is generated at the vibrating member 18 and the vibration is transmitted to the vibrating plate 3 via the support rod 2. When vibration from the vibrating member 18 is transmitted to the vibrating plate 3, the vibrating plate 3 is vibrated, and sound can be emitted to outside by vibrating the vibrating plate 3. Further, by mechanically connecting the vibrating plate 3 and other member, vibration is transmitted to the other member via the vibrating plate 3, and sound can be emitted to outside by vibrating the other member.

As described above, also in the case of Embodiment 5, vibration from the speaker driver unit 17 is transmitted to the vibrating plate 3 via the support rod 2 and therefore, similar to the case of Embodiment 1, sound can be emitted to outside by vibrating a member transmitted with vibration from the alarm sound emitting apparatus 13. Therefore, an effect similar to that in the case of an Embodiment 1 can be expected.

Further, since the magnet 5 is used as the fixing member of the vibrating plate 3, the alarm sound emitting apparatus 13 can easily be detached from the vibrating plate 3, and the alarm sound emitting apparatus 13 can easily be switched to install to an optimum position at inside of the compartment.

### Embodiment 6

Next, Embodiment 6 of the invention will be explained in reference to FIG. 11. According to Embodiment 6, an explanation will be given of a specific example of a location of installing the alarm sound emitting apparatus 13 having the above-described structure.

Although a location of installing the alarm sound emitting apparatus 13 is typically compartment inside, as an example of compartment inside, a trunk room 22 as shown by FIG. 11 can be pointed out. As shown by FIG. 11, the trunk room 22 is provided with a wall portion specifying the trunk room 22, a trunk room lid 23, and a spare tire house 24 for containing a spare tire.

As shown by FIG. 11, the alarm sound emitting apparatus 13 may be installed at the wall portion of the trunk room 22, may be installed at a wall portion specifying the spare tire house 24, or may be installed at the trunk room lid 23. In any of the cases, the wall portion or the lid of the portion installed with the alarm sound emitting apparatus 13 can be made to function as the vibrating plate, and sound having a desired sound pressure can be emitted to outside of the trunk room 22.

Further, when the alarm sound emitting apparatus 13 is installed to a vehicle, other than the trunk room 22, it is conceivable to install the alarm sound emitting apparatus 13 at inside of the compartment of the vehicle. Although it is conceivable to install the alarm sound emitting apparatus 13 at an engine room, in this case, there is needed a countermeasure for avoiding adverse influence on an engine owing to heat resistance, waterproof performance, dropping or the like.

It seems that inside of the compartment of the vehicle or the trunk room 22 is devised to acoustically shield from outside ordinarily and therefore, it seems that the alarm sound emitting apparatus 13 as described in the respective embodiments is particularly effective.

The inventors of the application have carried out the following test in order to confirm the effect by the above-described alarm sound emitting apparatus 13 and therefore, a result thereof will be explained.

First, when the inventors of the application have installed a speaker of about 120 dB at inside of a trunk of a vehicle and measured sound pressure at outside thereof, the inventors have confirmed that the sound pressure have attenuated to be equal to or lower than 85 dB. In contrast thereto, when the alarm sound emitting apparatus 13 having the structure shown in FIG. 4 is installed at the wall portion of the trunk room 22 and sound pressure at outside is measured, when the trunk room 22 is opened, the sound pressure is 90 dB, when the trunk room 22 is closed, the sound pressure is 88 dB, and a difference between the sound pressure when the trunk room 22 is opened and the sound pressure when the trunk room 22 is closed is as small as about 2 dB.

It seems that a volume for informing to outside of a vehicle is about 80 dB through 90 dB and therefore, even when the alarm sound emitting apparatus 13 is erroneously operated in the case in which the alarm sound emitting apparatus 13 is installed at inside of the compartment, the sound volume at inside of the compartment is about 80 dB through 90 dB and it seems that also damage caused to a person, an animal or the like at inside of the compartment becomes comparatively small when the sound volume is to such a degree.

Further, a concept of the above-described ‘compartment inside’ includes not only inside of the compartment of a vehicle or a building but also a space at inside of various apparatus surrounded by an outer shell member. Further, sound can also be emitted by attaching the alarm emitting apparatus 13 at the inner face of an outer shell member of various control panels and vibrating the outer shell member. By making the outer shell of the apparatus function as a sound emitting member in this way, a sound emitting port is dispensed with, complete waterproof, dust proof can be carried out, it is not also necessary to ensure a position or a space for attaching a sound emitting member at the outer shell of the apparatus, and a restriction in view of design of the outer shell of the apparatus can be reduced.

Further, it is also possible to attach the alarm sound emitting apparatus 13 at a rear face of a thin imaging apparatus to emit sound by vibrating a polymer panel, a back cover or the like constituting a screen. Further, in the case of a large-sized apparatus or the like, by attaching a plurality of the alarm sound emitting apparatus 13 to disperse in one plane, a sound field can be widened.

Although an explanation has been given of the embodiments of the invention as described above, characteristic constitutions of the above-described respective embodiments are scheduled to be combined pertinently. Further, the embodiments disclosed at this occasion is to be regarded to be exenplications in all the aspects and not to be restrictive. The range of the invention is shown by the scope of claims and includes all the changes within the significance and the range equivalent to the scope of claims.

The invention is effectively applicable to the alarm sound emitting apparatus emitting alarm sound.

1. An alarm sound emitting apparatus installed at an inner portion of an outer shell member surrounding a space, said alarm sound emitting apparatus comprising:
a vibration generating member for generating a vibration;
a vibration transmitting member for transmitting the vibration from the vibration generating member to the outer shell member; and
a fixing member for fixing the vibration transmitting member to the outer shell member attachably to and detachably from the outer shell member,
wherein an alarm sound is emitted to an outer portion of the space by vibrating the outer shell member.

2. The alarm sound emitting apparatus according to claim 1, further comprising:
an elastic member for pressing the vibration transmitting member to a side of the outer shell member.

3. The alarm sound emitting apparatus according to claim 1, wherein said vibration generating member is a piezoelectric element, said vibration transmitting member is a support rod for supporting the piezoelectric element and transmitting the vibration from the piezoelectric element to the outer shell member, said fixing member is a magnet for fixing the support rod to the outer shell member attachably to and detachably from the outer shell member.

4. The alarm sound emitting apparatus according to claim 3, further comprising:
an elastic member for pressing the support rod to a side of the outer shell member.

5. The alarm sound emitting apparatus according to claim 1, wherein said vibration generating member is a piezoelectric element, and said vibration transmitting member is a support rod for supporting the piezoelectric element and transmitting the vibration from the piezoelectric element and a magnet fixed to the support rod, transmitting the vibration transmitted from the piezoelectric element to the support rod to the outer shell member, and wherein said magnetic also serves as said fixing member for fixing the support rod to the outer shell member.

6. The alarm sound emitting apparatus according to claim 5, further comprising:
an elastic member for pressing the support rod and the magnet to a side of the outer shell member.

7. The alarm sound emitting apparatus according to claim 1, further comprising:
a cabinet for containing said vibration generating member and said vibration transmitting member therein,
wherein said fixing member fixes the cabinet to the outer shell member attachably to and detachably from the outer shell member.

8. The alarm sound emitting apparatus according to claim 7, further comprising:
an elastic member contained in the cabinet for pressing the vibration transmitting member to a side of the outer shell member.

9. The alarm sound emitting apparatus according to claim 1, wherein said vibration generating member is a vibrating unit including a vibrating member for generating a vibration, said vibration transmitting member is a vibration transmitting member for supporting the vibrating member and transmitting the vibration from the vibrating member to the outer shell member, said fixing member is a magnet for fixing the vibration transmitting member to the outer shell member.

10. The alarm sound emitting apparatus according to claim 9, further comprising:
an elastic member for pressing the vibration transmitting member to a side of the outer shell member.
